(19) United States
(12) Patent Application Publication
(10) Pub. No.: US 2026/0129474 A1
(43) Pub. Date: May 7, 2026

(54) LIFECYCLE MANAGEMENT FOR MACHINE LEARNING MODELS DEPLOYED IN RADIO ACCESS NETWORKS

(71) Applicant: AT&T Intellectual Property I, L.P., Atlanta, GA (US)

(72) Inventors: Thomas Novlan, Jonestown, TX (US); Isfar Tariq, Austin, TX (US); Salam Akoum, Austin, TX (US)

(21) Appl. No.: 18/936,756

(22) Filed: Nov. 4, 2024

(51) Int. Cl. H04W 24/02; H04W 16/18; H04W 92/10

(52) U.S. Cl. CPC H04W 24/02; H04W 16/18; H04W 92/10

(57) ABSTRACT

A method performed by a processing system including at least one processor includes determining a condition that was present during a training of a machine learning model that is deployed to optimize a radio access network and providing, to a user endpoint device connected to the radio access network, at least one of: an identifier that indicates the machine learning model or an identifier that indicates the condition. Further examples include receiving, from the user endpoint device, a second identifier of a machine learning model that was selected for deployment at the user endpoint device based on the at least one of: the identifier that indicates the machine learning model or the identifier that indicates the condition.

The present disclosure relates generally to wireless communications and relates more particularly to devices, non-transitory computer-readable media, and methods for managing the lifecycles of machine learning models deployed in radio access networks (RANs).

### BACKGROUND

An artificial intelligence (AI) and/or machine learning (ML) model is a data-driven algorithm that applies machine learning techniques to generate a set of desired outputs responsive to a set of inputs. For instance, an AI/ML model may be a deep neural network, a classical model such as a regression model, a support vector machine (SVM), a decision tree, or another type of data-driven algorithm. The AI/ML lifecycle involves various stages, including data collection, algorithm selection, model building, training, tuning, testing, deployment, management, monitoring, and inference. The training stage involves training the AI/ML model to learn the relationships between inputs and outputs using a set of training data, so that the model can infer an appropriate output for a previously unseen input.

### SUMMARY

In one example, the present disclosure describes a device, computer-readable medium, and method for managing the lifecycles of machine learning models deployed in radio access networks. For instance, in one example, a method performed by a processing system including at least one processor includes determining a condition that was present during a training of a machine learning model that is deployed to optimize a radio access network and providing, to a user endpoint device connected to the radio access network, at least one of: an identifier that indicates the machine learning model or an identifier that indicates the condition. Further examples include receiving, from the user endpoint device, a second identifier of a machine learning model that was selected for deployment at the user endpoint device based on the at least one of: the identifier that indicates the machine learning model or the identifier that indicates the condition.

In another example, a non-transitory computer-readable medium stores instructions which, when executed by a processor, cause the processor to perform operations. The operations include determining a condition that was present during a training of a machine learning model that is deployed to optimize a radio access network and providing, to a user endpoint device connected to the radio access network, at least one of: an identifier that indicates the machine learning model or an identifier that indicates the condition. Further operations include receiving, from the user endpoint device, a second identifier of a machine learning model that was selected for deployment at the user endpoint device based on the at least one of: the identifier that indicates the machine learning model or the identifier that indicates the condition.

In another example, a device includes a processor and a computer-readable medium storing instructions which, when executed by the processor, cause the processor to perform operations. The operations include determining a condition that was present during a training of a machine learning model that is deployed to optimize a radio access network and providing, to a user endpoint device connected to the radio access network, at least one of: an identifier that indicates the machine learning model or an identifier that indicates the condition. Further operations include receiving, from the user endpoint device, a second identifier of a machine learning model that was selected for deployment at the user endpoint device based on the at least one of: the identifier that indicates the machine learning model or the identifier that indicates the condition.

### BRIEF DESCRIPTION OF THE DRAWINGS

The teachings of the present disclosure can be readily understood by considering the following detailed description in conjunction with the accompanying drawings, in which:

FIG. 1 illustrates an example network, or system, in which examples of the present disclosure may operate;

FIG. 2 illustrates a flowchart of an example method for managing the lifecycles of machine learning models deployed in radio access networks, in accordance with the present disclosure;

FIG. 3 illustrates a flowchart of an example method for managing the lifecycles of machine learning models deployed in radio access networks, in accordance with the present disclosure; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure manages the lifecycles of machine learning models deployed in radio access networks (RANs). As discussed above, an AI/ML model is a data-driven algorithm that applies machine learning techniques to generate a set of desired outputs responsive to a set of inputs. For instance, an AI/ML model may be a deep neural network, a classical model such as a regression model, a support vector machine (SVM), a decision tree, or another type of data-driven algorithm.

Recent trends in the field of RANs have come to view AI/ML models as feasible and scalable tools for network optimization. Optimization is a fundamental challenge in deploying large-scale cellular networks, as configuration and adaptation of system parameters can have significant impact on key performance indicators (KPIs) such as system capacity, user quality of experience (QoE), latency, reliability, coverage, numbers of active users, and the like. Optimization is especially critical for Fifth Generation (5G) RANs, which are heterogeneous in terms of frequency bands/ranges, macro and small cell deployments, diverse service offerings traffic characteristics, and coexistence of different architectures (including centralized virtual RAN functions and distributed nodes to support latency-sensitive edge computing and private networks).

ML models used for network optimization often rely on historical data for deriving system models and for training, as well as real-time or near-real-time data collection to adapt to different network conditions. AI/ML-driven techniques may support a variety of use cases, including channel state information (CSI) optimization, beam management, and positioning. Many of these use cases share common requirements in terms of data collection, KPIs for monitoring, and lifecycle management procedures. At the same time, different use cases may have vastly different requirements in terms of the impact on network nodes or functionalities. This implies that the appropriate implementation of different AI/ML techniques may involve multiple interfaces, signaling procedures, processing requirements (e.g., including requirements on data aggregation or co-location with different nodes/functions), and lifecycle management requirements.

For a user endpoint device and/or a network to be able to make certain decisions (based on machine learning model-based performance monitoring or otherwise), a model identification and lifecycle management procedure needs to be established. The model identification procedure needs to be flexible, so that the procedure can cover diverse types of models, cover locations where model inferences may be performed (e.g., user endpoint device and/or network), and support all collaboration levels between the user endpoint device and the network. The model identification procedure will also initiate the functionalities applicable to different AI and/or ML use cases in various conditions and/or scenarios.

A framework which enables both model identification-based lifecycle management and functionality-based lifecycle management in a unified manner that ensures consistency between training and inference regarding network-side additional conditions should support the following features and requirements: (1) machine learning model identification to achieve alignment on the network side additional conditions between the network side and the user endpoint device side; (2) machine learning model training at the network and transfer to the user endpoint device, where the machine learning model has been trained under additional conditions; (3) information and/or indication provided to the user endpoint device of any network side additional conditions; and (4) consistency assisted by monitoring (by the user endpoint device and/or the network) of the performance of the user endpoint device-side candidate models and/or functionalities to select models and/or functionalities.

Within the context of the present disclosure, an AI/ML “lifecycle” is understood to involve various stages, including data collection, algorithm selection, model building, training, tuning, testing, deployment, management, monitoring, and inference. The training stage involves training the AI/ML model to learn the relationship(s) between inputs and outputs using a set of training data, so that the model can infer an appropriate output for a previously unseen input. Examples of the present disclosure enable additional conditions (e.g., network conditions) that were present at the time a machine learning model was trained on the network side of a RAN to be provided to a user endpoint device as part of a lifecycle management procedure for the machine learning model. Knowledge of these additional conditions may help a user endpoint device to select an appropriate machine learning model on the user endpoint device side for the additional conditions, or to modify training of a machine learning model to account for the additional conditions. This ensures consistency between the model training and inference stages on both the network and user endpoint device sides. Examples of the present disclosure also enable model identification and model identifier-based signaling in a functionality which provides model-level management by the network of one-sided models residing on the user endpoint device side and of the user endpoint device side of two-sided models.

Advantages of the present disclosure support user endpoint device-side one sided models with model transfer, pairing of two-sided models, and alignment between the user endpoint device and the network with respect to additional conditions under which models deployed on the network side were trained.

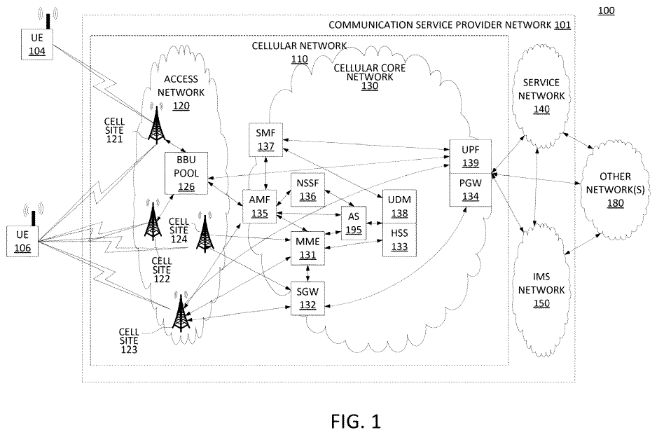

Moreover, although examples of the present disclosure are discussed within the context of a network element communicating network-side conditions to a user endpoint device to guide the selection of a machine learning model by the user endpoint device, it will be appreciate that examples of the present disclosure may also support the opposite (e.g., a user endpoint device may communicate user endpoint device-side conditions to the network element to guide the selection of a machine learning model on the network side). These and other aspects of the present disclosure are discussed in greater detail in connection with FIGS. 1-4, below.

FIG. 1 illustrates an example network, or system, 100 in which examples of the present disclosure may operate. In one example, the system 100 includes a communication service provider network 101. The communication service provider network 101 may comprise a cellular network 110 (e.g., a 5G network, a 4G/Long Term Evolution (LTE)/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a cloud RAN. A cloud RAN, however, is just one example of a RAN with which MU-MIMO may work. MU-MIMO works with all types of RANs, including distributed RANS (D-RANs), centralized RANs (C-RANs), virtualized RANS (V-RANs), and open RANS (O-RANs).

For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs) or radio units (RUs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as MIMO antennas, and millimeter wave antennas.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In one example, baseband unit functionality may be split into a centralized unit (CU) and a distributed unit (DU). In addition, the CU and the DU may be physically separate from one another. For instance, a DU may be situated with an RU/RRH at a cell site, while a CU may be in a centralized location hosting multiple CUs. Alternatively, or in addition, a single CU may serve multiple DUs and/or RUs/RRHs. In accordance with the present disclosure a “base station” may therefore comprise at least a BBU (e.g., in one example, a CU and/or a DU), and may further include at least one RRH/RU.

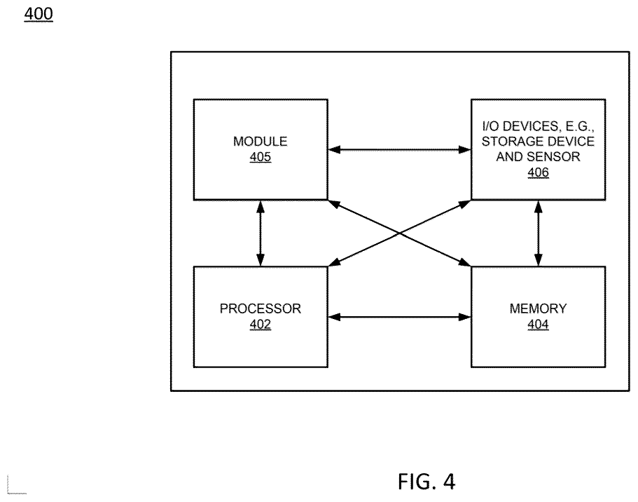

In accordance with the present disclosure, any one or more of cell sites 121-124 may be deployed with antenna and radio infrastructures, including MIMO and millimeter wave antennas. Furthermore, in accordance with the present disclosure, a base station (e.g., cell sites 121-124 and/or baseband units within BBU pool 126) may comprise all or a portion of a computing system, such as computing system 400 as depicted in FIG. 4, and may be configured to perform steps, functions, and/or operations in connection with examples of the present disclosure for service-based allocation of fixed bandwidth parts.

In one example, access network 120 may include both 4G/LTE and 5G/NR radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network nodes such as Mobility Management Entity (MME) 131 and Serving Gateway (SGW) 132 support various functions as part of the cellular network 110. For example, MME 131 is the control node for LTE access network components, e.g., eNodeB aspects of cell sites 121-124. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 5G network components, 3G network components, etc. Thus, cellular core network 130 may comprise an integrated network, e.g., including any two or more of 2G-5G infrastructures and technologies (or any future wireless infrastructures and technologies to be deployed, e.g., 6G), and the like. For example, as illustrated in FIG. 1, cellular core network 130 further comprises 5G components, including: an access and mobility management function (AMF) 135, a network slice selection function (NSSF) 136, a session management function (SMF) 137, a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., a “5GC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure may also relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1. It should be noted that intermediate devices and links between MME 131, SGW 132, cell sites 121-124, PGW 134, AMF 135, NSSF 136, SMF 137, UDM 138, and/or UPF 139, and other components of system 100 are also omitted for clarity, such as additional routers, switches, gateways, and the like.

FIG. 1 also illustrates various mobile endpoint devices, e.g., user equipment (UE) 104 and 106. Each of the UEs 104 and 106 may comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). For instance, each of the UEs 104 and 106 may include one or more radio frequency (RF) transceivers for cellular communications and/or for non-cellular wireless communications. In one example, each of the UEs 104 and 106 may be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive and/or to transmit multi-path and/or spatial diversity signals.

In one example, each of the UEs 104 and 106 may comprise all or a portion of a computing system, such as computing system 400 depicted in FIG. 4, and may be configured to perform steps, functions, and/or operations in connection with examples of the present disclosure for managing the lifecycles of machine learning models deployed in radio access networks. In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

As illustrated in FIG. 1, UE 104 may access wireless services via the cell site 121 (e.g., NR alone, where cell site 121 comprises a gNB), while UE 106 may access wireless services via any of the cell sites 121-124 located in the access network 120 (e.g., for NR non-dual connectivity, for LTE non-dual connectivity, for NR-NR DC, for LTE-LTE DC, for EN-DC, and/or for NE-DC). For instance, in one example, UE 106 may establish and maintain connections to the cellular core network 130 via one or multiple gNBs (e.g., cell sites 121 and 122 and/or cell sites 121 and 122 in conjunction with BBU pool 126 and/or various other components, such as a CU and/or a DU). In another example, UE 106 may establish and maintain connections to the cellular core network 130 via a gNB (e.g., cell site 122 and/or cell site 122 in conjunction with BBU pool 126) and an eNodeB (e.g., cell site 124), respectively. In addition, either the gNB or the eNodeB may comprise a PCell, and the other may comprise a SCell for carrier aggregation and/or dual connectivity. Similarly, UE 106 may communicate with any of the cell sites 121 and 122 using carrier aggregation (CA) (e.g., in accordance with a CA technique). Furthermore, either or both of NR/5G and or EPC (4G/LTE) core network components may manage the communications between UE 106 and the cellular network 110 via cell site 122 and cell site 124.

In one example, UE 106 may also utilize different antenna arrays for 4G/LTE and 5G/NR, respectively. For instance, 5G antenna arrays may be arranged for beamforming in a frequency band designated for 5G high data rate communications. For instance, the antenna array for 5G may be designed for operation in a frequency band between 1 GHz and 7.125 GHz. In contrast, an antenna array for 4G may be designed for operation in a frequency band less than 5 GHz, e.g., 500 MHz to 3 GHz. In addition, in one example, the 4G antenna array (and/or the RF or baseband processing components associated therewith) may not be configured for and/or be capable of beamforming. Accordingly, in one example, UE 106 may turn off a 4G/LTE radio, and may activate a 5G radio to send a request to activate a 5G session to cell site 122 (e.g., when it is chosen to operate in a non-DC mode or an intra-RAT dual connectivity mode), or may maintain both radios in an active state for multi-radio (MR) dual connectivity (MR-DC).

In accordance with the present disclosure, UE 106 may attach to any cell (e.g., a cell site/base station) of access network 120 and may exchange identifiers with the cell to align machine learning models that are deployed at the network side and/or UE side to optimize the communication service provider network 101. For instance, as discussed above, one or more machine learning models may be deployed to optimize the communication service provider network 101. The machine learning models may be deployed on the network side only, on the UE side only, or on both the network and UE sides. In some cases, it may be necessary to ensure consistency between network side and UE side machine learning models to support optimization. In some examples of the present disclosure, a network element (e.g., a cell site/base station or an application server such as the AS 195) may deploy a machine learning model to support optimization. The network element may provide either or both of the UE 104 or UE 106 with one or more identifiers, where the identifiers may indicate the machine learning model that is deployed at the network element and/or a condition (e.g., a network condition such as throughput, latency, network traffic volume, network element configuration parameter, or the like) that was present in the network at the time the machine learning model was trained.

The UE 104 or 106 may use the one or more identifiers to select an appropriate machine learning model for deployment on the UE side. For instance, the UE 104 or UE 106 may select a machine learning model that corresponds to a machine learning model indicated by an identifier of the one or more identifiers (e.g., the same machine learning model deployed at the network element). Alternatively or in addition, the UE 104 or UE 106 may select a machine learning model that is different from the machine learning model deployed at the network element, but that is determined to best support a condition indicated by an identifier of the one or more identifiers (where support is understood to mean that the selected machine learning model will ensure a specified network performance requirement in the presence of the condition).

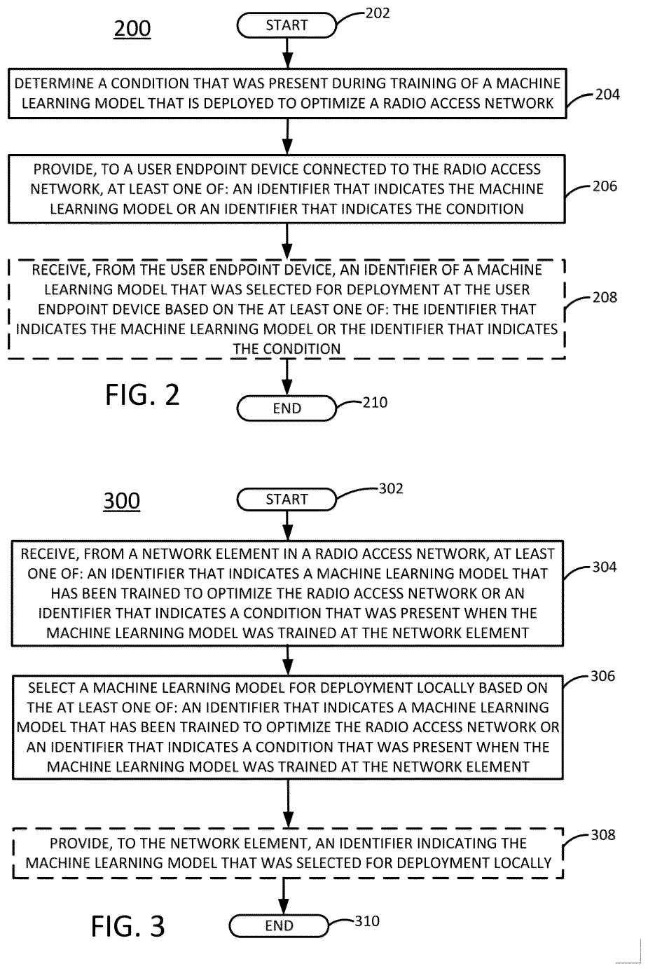

It should be noted that examples of the present disclosure as described herein primarily in connection with steps, functions, and/or operations that are performed by a cellular base station and/or the UE 104 or UE 106. For instance, FIG. 2 illustrates a flowchart of an example method that may be performed by a serving cell (e.g., a base station and/or any one or more components thereof). However, in other, further, and different examples, various steps, functions, and/or operations as described in connection with FIG. 2, or as described elsewhere herein, may alternatively or additionally be performed by one or more other components. For instance, various steps, functions, and/or operations may alternatively or additionally be performed by a processing system in cellular core network 130, such as application server (AS) 195, AMF 135, SMF 137, MME 131, or the like. To illustrate, in an example in which the foregoing is performed by a base station/cell site, the transmitting of the at least one instruction may be via the base station/cell site to UE 106. However, in an example in which the foregoing may be performed by AS 195, AMF 135, SMF 137, MME 131, or the like, the instruction may be to a cell sites/base station serving UE 106 to activate uplink MU-MIMO communications.

The foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In one example, any one or more of cell sites 121-124 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. Thus, these and other modifications are all contemplated within the scope of the present disclosure.

To further aid in understanding the present disclosure, FIG. 2 illustrates a flowchart of an example method 200 for managing the lifecycles of machine learning models deployed in radio access networks, in accordance with the present disclosure. In one example, the method 200 may be performed by an application server that is configured to ensure consistency between training and inference for machine learning models that are deployed on both the network-side and the user endpoint device-side, such as the AS 195 illustrated in FIG. 1. However, in other examples, the method 200 may be performed by another device, such as the processor 402 of the system 400 illustrated in FIG. 4. For the sake of example, the method 200 is described as being performed by a processing system.

The method 200 begins in step 202. In step 204, the processing system may determine a condition that was present during training of a machine learning model that is deployed to optimize a radio access network.

In one example, the processing system may be part of a network element of the RAN, such as a base station (e.g., a gNodeB). In one example, the machine learning model may comprise at least one of: a deep neural network, a classical model, a support vector machine (SVM), or a decision tree. In one example, the machine learning model may comprise a one-sided model. The one-sided model may be deployed at (i.e., perform inference at) either one of the network side (e.g., at a base station) or the user endpoint device side (e.g., at a user endpoint device). In another example, the machine learning model may comprise a two-sided model (e.g., a pair of models, where one model is deployed at each of the network side and the user endpoint device side). For one-sided models that reside at either the user endpoint device or in the network, one or more models may be deployed and used at the user endpoint device or in the network. For two-sided models, multiple models may also be deployed.

Whether the machine learning model is one-sided or two-sided, it is important to monitor the performance of the machine learning model for various reasons, including: (1) lack of performance guarantee (depending on the type of model used); (2) changes in deployment options and deployment environment characteristics after model deployment (which may result in sub-optimal performance); and (3) informing model selection decisions when multiple models are available. For one-sided models deployed on the user endpoint device side, monitoring is also important to detect modification of the model (or input/output parameters of the model) by a third party cloud, without notification to the network (which may result in performance degradation).

In one example, when the machine learning model was trained at the network side, the machine learning model may have been trained under one or more conditions that were not present for training at the user endpoint device side or were not visible or made transparent to the user endpoint device. These one or more conditions may include, for example, network conditions that may have affected model training, data collection, and/or inference by the processing system. For instance, the network conditions may include latency, network traffic volume, throughput, network element configuration parameters, a status of machine learning or artificial intelligence models running on the network (which can impact performance of the machine learning model(s) on the user endpoint device side, an environmental condition (e.g., line of site or non-line of site), or the like). Thus, the condition that is determined in step 204 may comprise one or more of these conditions and/or other conditions. That is, multiple conditions may be determined in step 204; the condition referenced in step 204 may be one of many conditions.

In step 206, the processing system may provide, to a user endpoint device connected to the radio access network, at least one of: an identifier that indicates the machine learning model or an identifier that indicates the condition.

The type of the model identification procedure may affect how examples of the present disclosure identify or indicate conditions under which a machine learning model was trained on the network side to a user endpoint device. There are many types of model identification procedures that can be defined, including Type A and Type B. Type A model identification is performed offline, while Type B model identification is performed over the air (e.g., over an air interface of the RAN). Type B model identification is beneficial for a variety of purposes, including identifying new or updated machine learning models that have been trained and/or transferred and identifying machine learning models that were trained using additional conditions (e.g., dataset identification) for the trained model.

Thus, in one example where the model identification procedure is a Type A procedure, the processing system may provide the condition to the user endpoint device in an offline manner.

In another example where the model identification procedure is Type B, the processing system may provide an identifier to the user endpoint device over the air, where the identifier is an identifier that indicates the machine learning model, an identifier that indicates the condition (or conditions), or another type of identifier over the air. The processing system may also provide an identifier to the user endpoint device over the air, where the identifier is an identifier that indicates the machine learning model, an identifier that indicates the condition (or conditions), or another type of identifier over the air in cases where the machine learning model is trained on the network side and subsequently transferred (e.g. delivered as either a full or partial model over the air interface) to the user endpoint device. Where the model is delivered as a full model, the model may comprise a new model with parameters of the model structure. Where the model is delivered as a partial model, the processing system may deliver only parameters of a structure of a model that is already known to reside at the user endpoint device.

An identifier that indicates the machine learning model may help the user endpoint device to select the same machine learning model for deployment on the user endpoint device side, while an identifier that indicates the condition may help the user endpoint device to select a machine learning model (which may be the same as or different from the machine learning model that is trained and deployed at the processing system) that can be deployed on the user endpoint device side that supports the condition (where supporting a condition means ensuring that specified network performance requirements are met in the presence of the condition).

In optional step 208 (illustrated in phantom), the processing system may receive, from the user endpoint device, an identifier (broadly a second identifier) of a machine learning model that was selected for deployment at the user endpoint device based on the at least one of: the identifier that indicates the machine learning model or the identifier that indicates the condition.

In one example, the identifier received from the user endpoint device may match the identifier provided to the user endpoint device in step 206. For instance, if the processing system provides an identifier in step 206 that indicates a machine learning model, then the user endpoint device may confirm the selection of the corresponding machine learning model by providing the same identifier indicating the machine learning model in step 208. In another example, if the processing system provides an identifier in step 206 that indicates the condition, then the user endpoint device may provide an identifier in step 208 that indicates a machine learning model selected by the user endpoint device based on the condition (e.g., a machine learning model that the user endpoint device has determined capable of supporting the condition).

In one example, the machine learning model that was selected for deployment at the user endpoint device may comprise at least one of: a deep neural network, a classical model, a support vector machine (SVM), or a decision tree.

Step 208 may be considered optional, because it may not be necessary in all cases for the user endpoint device to confirm to the network what machine learning model is deployed on the user endpoint device side or what condition(s) that the machine learning model deployed on the user endpoint device side may support. The method 200 may then end in step 210.

FIG. 3 illustrates a flowchart of an example method 300 for managing the lifecycles of machine learning models deployed in radio access networks, in accordance with the present disclosure. In one example, the method 300 may be performed by a user endpoint device that is configured to ensure consistency between training and inference for machine learning models that are deployed on both the network-side and the user endpoint device-side, such as either of the UEs 104 or 106 illustrated in FIG. 1. However, in other examples, the method 300 may be performed by another device, such as the processor 402 of the system 400 illustrated in FIG. 4. For the sake of example, the method 300 is described as being performed by a processing system.

The method 300 begins in step 302. In step 304, the processing system may receive, from a network element in a radio access network, at least one of: an identifier that indicates a machine learning model that has been trained to optimize the radio access network or an identifier that indicates a condition that was present during training of the machine learning model at the network element.

In one example, the processing system may be part of a user endpoint device that is connected to the RAN, while the network element may comprise, for instance, a base station (e.g., a gNodeB) of the RAN. In one example, the machine learning model may comprise at least one of: a deep neural network, a classical model, a support vector machine (SVM), or a decision tree. In one example, the machine learning model may comprise a one-sided model. The one-sided model may be deployed at (i.e., perform inference at) either one of the network side (e.g., at a base station) or the user endpoint device side (e.g., at a user endpoint device). In another example, the machine learning model may comprise a two-sided model (e.g., a pair of models, where one model is deployed at each of the network side and the user endpoint device side). For one-sided models that reside at either the user endpoint device or in the network, one or more models may be deployed and used at the user endpoint device or in the network. For two-sided models, multiple models may also be deployed.

In one example, when the machine learning model was trained at the network side, the machine learning model may have been trained under one or more conditions that were not present for training at the user endpoint device side or were not visible or made transparent to the user endpoint device. These conditions may include, for example, network conditions that may have affected model training, data collection, and/or inference by the processing system. For instance, the network conditions may include latency, network traffic volume, throughput, network element configuration parameters, or the like. Thus, the condition that is indicated by an identifier received in step 304 may comprise one or more of these conditions and/or other conditions. That is, multiple conditions may be indicated by an identifier that is received in step 304; the condition indicated by the identifier may be one of many conditions.

In step 306, the processing system may select a machine learning model for deployment locally based on the at least one of: the identifier that indicates the machine learning model that has been trained to optimize the radio access network or the identifier that indicates at least one condition that was present during training of the machine learning model at the network element.

As discussed above, an identifier that indicates the machine learning model that has been trained to optimize the RAN (and deployed at the network element) may help the user endpoint device to select the same machine learning model for deployment on the user endpoint device side, while an identifier that indicates the condition may help the user endpoint device to select a machine learning model (which may be the same as or different from the machine learning model that is trained and deployed at the network element) that can be deployed on the user endpoint device side that supports the condition.

In one example, the machine learning model that is selected for deployment locally comprises at least one of: a deep neural network, a classical model, a support vector machine (SVM), or a decision tree.

In optional step 308 (illustrated in phantom), the processing system may provide, to the network element, an identifier (broadly a second identifier) indicating the machine learning model that was selected for deployment locally.

In one example, the identifier sent to the network element may match the identifier received from the network element in step 304. For instance, if the network element provides an identifier in step 304 that indicates a particular machine learning model, then the processing system may confirm the selection of the corresponding particular machine learning model by providing the same identifier indicating the machine learning model in step 308. In another example, if the network element provides an identifier in step 304 that indicates the condition, then the processing system may provide an identifier in step 308 that indicates a machine learning model selected by the processing system based on the condition (e.g., a machine learning model that the processing system has determined being capable of supporting the condition).

Step 308 may be considered optional, because it may not be necessary in all cases for the processing system to confirm to the network element what machine learning model is deployed on the user endpoint device side or what condition(s) that the machine learning model deployed on the user endpoint device side may support. The method 300 may then end in step 310.

Although not expressly specified above, one or more steps of the method 200 or method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 or FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 4 depicts a high-level block diagram of a computing device specifically programmed to perform the functions described herein. For example, any one or more components or devices illustrated in FIG. 1 or described in connection with the method 200 or method 300 may be implemented as the system 400. For instance, an application server or network element (such as might be used to perform the method 200) or a user endpoint device (such as might be used to perform the method 300) could be implemented as illustrated in FIG. 4.

As depicted in FIG. 4, the system 400 comprises a hardware processor element 402, a memory 404, a module 405 for managing the lifecycles of machine learning models deployed in radio access networks, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for managing the lifecycles of machine learning models deployed in radio access networks may include circuitry and/or logic for aligning network-side and user endpoint device-side machine learning models that are used for optimization of RANs. The input/output devices 406 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for managing the lifecycles of machine learning models deployed in radio access networks (e.g., a software program comprising computer-executable instructions) can be loaded into memory 404 and executed by hardware processor element 402 to implement the steps, functions or operations as discussed above in connection with the example method 200 or example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for managing the lifecycles of machine learning models deployed in radio access networks (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
determining, by a processing system including at least one processor, a condition that was present during a training of a machine learning model that is deployed to optimize a radio access network; and
providing, by the processing system to a user endpoint device connected to the radio access network, at least one of: an identifier that indicates the machine learning model or an identifier that indicates the condition.

2. The method of claim 1, wherein the processing system is part of a network element of the radio access network.

3. The method of claim 2, wherein the network element is at least one of: an application server or a base station.

4. The method of claim 1, wherein the condition is one of a plurality of conditions that was present during the training of the machine learning model, and the identifier that indicates the condition indicates the plurality of conditions.

5. The method of claim 1, wherein the condition comprises at least one of: a latency of the radio access network, a network traffic volume of the radio access network, a throughput of the radio access network, or a configuration parameter of a network element.

6. The method of claim 1, wherein the machine learning model that is deployed to optimize the radio access network comprises a one-side machine learning model deployed in the radio access network.

7. The method of claim 1, wherein the machine learning model that is deployed to optimize the radio access network comprises a one-side machine learning model deployed at the user endpoint device.

8. The method of claim 1, wherein the providing is performed offline.

9. The method of claim 1, wherein the providing is performed over an air interface of the radio access network.

10. The method of claim 1, further comprising:
receiving, by the processing system from the user endpoint device, a second identifier of a machine learning model that was selected for deployment at the user endpoint device based on the at least one of: the identifier that indicates the machine learning model or the identifier that indicates the condition.

11. The method of claim 10, wherein the machine learning model that is deployed to optimize the radio access network comprises one half of a two-sided machine learning model, and the machine learning model that was selected for deployment at the user endpoint device comprises another half of the two-sided machine learning model.

12. The method of claim 10, wherein the machine learning model that was selected for deployment at the user endpoint device is a same machine learning model as the machine learning model that is deployed to optimize the radio access network.

13. The method of claim 1, wherein the machine learning model that is deployed to optimize the radio access network is deployed at a network element of which the processing system is a part.

14. The method of claim 10, wherein the machine learning model that was selected for deployment at the user endpoint device is different from the machine learning model that is deployed to optimize the radio access network.

15. The method of claim 14, wherein the machine learning model that was selected for deployment at the user endpoint device was selected to ensure a specified network performance requirement in a presence of the condition.

16. The method of claim 10, wherein each of the machine learning model that was selected for deployment at the user endpoint device and the machine learning model that is deployed to optimize the radio access network is at least one of: a deep neural network, a classical model, a support vector machine, or a decision tree.

17. A non-transitory computer-readable medium storing instructions which, when executed by a processing system including at least one processor, cause the processing system to perform operations, the operations comprising:
determining a condition that was present during a training of a machine learning model that is deployed to optimize a radio access network; and
providing, to a user endpoint device connected to the radio access network, at least one of: an identifier that indicates the machine learning model or an identifier that indicates the condition.

18. The non-transitory computer-readable medium of claim 17, wherein the operations further comprise:
receiving, from the user endpoint device, a second identifier of a machine learning model that was selected for deployment at the user endpoint device based on the at least one of: the identifier that indicates the machine learning model or the identifier that indicates the condition.

19. A device comprising:
a processing system including at least one processor; and
a computer-readable medium storing instructions which, when executed by the processing system, cause the processing system to perform operations, the operations comprising:
determining a condition that was present during a training of a machine learning model that is deployed to optimize a radio access network; and
providing, to a user endpoint device connected to the radio access network, at least one of: an identifier that indicates the machine learning model or an identifier that indicates the condition.

20. The device of claim 19, wherein the operations further comprise:
receiving, from the user endpoint device, a second identifier of a machine learning model that was selected for deployment at the user endpoint device based on the at least one of: the identifier that indicates the machine learning model or the identifier that indicates the condition.
